(19) United States
(12) Patent Application Publication
(10) Pub. No.: US 2006/0103598 A1
(43) Pub. Date: May 18, 2006

(54) Plasma display panel and method of driving the plasma display panel

(75) Inventors: Seok-Gyun Woo, Suwon-si (KR); Hyun Kim, Suwon-si (KR)

Correspondence Address: H.C. PARK & ASSOCIATES, PLC, 8500 LEESBURG PIKE, SUITE 7500, VIENNA, VA, 22182, US

(73) Assignee: Samsung SDI Co., Ltd.

(21) Appl. No.: 11/274,350

(22) Filed: Nov. 16, 2005

(30) Foreign Application Priority Data
Nov. 18, 2004 (KR) 10-2004-0094424

(51) Int. Cl. G09G 3/28

(52) U.S. Cl. 345/63

(57) ABSTRACT

A plasma display panel including a first substrate facing a second substrate, partition walls arranged between the first substrate and the second substrate and defining a plurality of discharge cells, pairs of R, G, B discharge electrodes for generating a discharge in the discharge cells, a fluorescent layer emitting red, green, and blue light arranged inside the discharge cells, and discharge gas in the discharge cells.

### CROSS-REFERENCE TO RELATED APPLICATION

This application claims priority to and the benefit of Korean Patent Application No. 10-2004-0094424, filed on Nov. 18, 2004, which is hereby incorporated by reference for all purposes as if fully set forth herein.

### BACKGROUND OF THE INVENTION

1. Field of the Invention

The present invention relates to a plasma display panel and a method of driving the panel, and more particularly, to a plasma display panel having a novel structure for improving resolution.

2. Discussion of the Background

Plasma display panels have been recently highlighted as a replacement for the conventional cathode-ray tube display. Generally, the plasma display panel has discharge gas that is filled and sealed between two substrates including a plurality of electrodes, and a discharge voltage is applied to the electrodes, thus generating ultraviolet rays. The ultraviolet rays excite a fluorescent layer to obtain a desired image.

FIG. 1 is an exploded perspective view of a conventional three-electrode surface-discharge plasma display panel. FIG. 2 is a cross-sectional view of a discharge cell taken along line II-II of the plasma display panel of FIG. 1.

Referring to FIG. 1, the plasma display panel I includes a first panel 110 and a second panel 120.

The first panel 110 includes a first substrate 111, scan electrode lines 112 and sustain electrode lines 113 on the first substrate 111, a first dielectric layer 115 covering the scan and sustain electrode lines, and a first protective film 116 covering the first dielectric layer 115. A sustain electrode pair 114 includes a scan electrode line 112 and a sustain electrode line 113. The scan electrode lines 112 and the sustain electrode lines 113 include bus electrodes 112a, 113a, which are made of metal materials for increasing conductivity, and transparent electrodes 112b, 113b, which are made of transparent conductive materials such as indium tin oxide (ITO), respectively.

The second panel 120 includes a second substrate 121, address electrode lines 122 arranged in a direction substantially perpendicular to the scan electrode lines 112 and the sustain electrode line 113, a second dielectric layer 123 covering the address electrode lines 122, partition walls 124 on the second dielectric layer 123 to define discharge cells Ce, a fluorescent layer 125 arranged in the discharge cells Ce, and a second protective film 128 arranged on the fluorescent layer 125 to protect the fluorescent layer 125. A discharge gas is filled inside the discharge cells Ce.

FIG. 3 is a diagram schematically illustrating the electrode arrangement of FIG. 1. Scan electrode lines Y1, . . . ,Yn and sustain electrode lines X1, . . . , Xn are arranged to be parallel to each other. Address electrode lines A1r, . . . , Amb are arranged substantially perpendicular to the scan and sustain electrode lines, and an area where an address electrode, a scan electrode, and a sustain electrode cross define a discharge cell. The discharge cells include red (R) discharge cells RCe, green (G) discharge cells GCe, and blue (B) discharge cells BCe. One pixel Px includes a R discharge cell RCe, a G discharge cell GCe, and a B discharge cell BCe, and each pixel Px may display red, green, and blue.

FIG. 4 is a block diagram schematically illustrating a device for driving the plasma display panel 1 of FIG. 1.

Referring to FIG. 4, the driving device includes an image processor 400, a logic controller 402, a Y driver 404, an address driver 406, and an X driver 408.

The image processor 400 receives an external image signal and processes the signal to output an internal image signal. The logic controller 402 receives the internal image signal and outputs address drive control signal S_{A}, Y drive control signal S_{Y}, and X drive control signal S_{X} after performing gamma correction, automatic power control (APC), etc. The Y driver 404 receives the Y drive control signal S_{Y} and applies a reset pulse including a rising ramp and a falling ramp to initialize a discharge, a scan pulse, and a sustain pulse to the scan electrode lines Y1, . . . , Yn during a reset period (PR of FIG. 5), an address period (PA of FIG. 5), and a sustain discharge period (PS of FIG. 5), respectively. The address driver 406 receives the address drive control signal S_{A} and outputs a display data signal to the address electrode lines A1r, . . . , Amb to select cells to be turned on among all cells during the address period (PA of FIG. 5). The X driver 408 receives the X drive control signal S_{X} and applies a bias voltage (Vb of FIG. 5) during the reset period and the address period, and sustain pulses during the sustain period, to the sustain electrode lines X1, . . . ,Xn.

FIG. 5 is a diagram illustrating driving signals for driving the plasma display panel of FIG. 1.

Referring to FIG. 5, a unit frame for displaying an image is divided into a plurality of sub-fields SF. A sub-field SF is divided into the reset period PR for performing the initializing discharge for the discharge cells, the address period PA for selecting discharge cells to be turned on, and the sustain period PS for sustain discharging selected discharge cells depending on gray-scale weight

During the reset period PR, a rising ramp and falling ramp are applied to the scan electrode lines Y1, . . . ,Yn, a bias voltage is applied to the sustain electrode lines X1, . . . ,Xn while applying the falling ramp, and a ground voltage is applied to the address electrode lines A1r, . . . ,Amb, thereby performing the initializing discharge for the discharge cells.

During the address period PA, a scan pulse is applied to the scan electrode lines Y1, . . . , Yn and display data signals for selecting discharge cells to be turned on are applied to the address electrode lines A1r, . . . ,Amb.

During the sustain period PS, a sustain pulse is alternately applied to the scan electrode lines and the sustain electrode lines to generate sustain discharge in the selected discharge cells depending on gray-scale weight.

A great deal of research have been undertaken to improve the resolution and light emitting efficiency of the three-electrode surface-discharge plasma display panel of FIG. 1. However, the narrow space (D of FIG. 1) of about 60 μm to 120 μm between sustain electrodes limits the amount that a pixel may be reduced in size in order to increase the panel's resolution. Further, a driver is required for driving each electrode of the plasma display panel having the three-electrode surface-discharge structure, thus increasing the cost of producing the plasma display panel.

### SUMMARY OF THE INVENTION

The present invention provides a plasma display panel having a novel structure that improves resolution.

Additional features of the invention will be set forth in the description which follows, and in part will be apparent from the description, or may be learned by practice of the invention.

The present invention discloses a plasma display panel including a first substrate facing a second substrate, partition walls arranged between the first substrate and the second substrate and defining a plurality of discharge cells, a first discharge electrode pair, a second discharge electrode pair, and a third discharge electrode pair for generating a discharge in a discharge cell, a first fluorescent layer for emitting red light, a second fluorescent layer for emitting green light, and a third fluorescent layer for emitting blue light arranged in the discharge cell, and discharge in the discharge cell.

The present invention also discloses a method of driving a plasma display panel. The plasma display panel includes a first substrate and a second substrate, partition walls arranged between the first substrate and the second substrate and defining a plurality of discharge cells, pairs of R, G, B discharge electrodes arranged in the partition walls to enclose the discharge cells, each pair of R, G, and B discharge electrodes comprising a first electrode and a second electrode arranged substantially perpendicular to each other, a fluorescent layer emitting red, green, and blue light arranged adjacent to the pairs of R, G, B discharge electrodes, and discharge gas in the discharge cells. The method comprises dividing a unit frame into a plurality of sub-fields having respective gray-scale weights, a sub-field being divided into a reset period for initializing the discharge cells, an address period for selecting discharge cells to be turned on, and a sustain period for performing sustain discharge in the select discharge cells corresponding to the respective gray-scale weight, and applying driving signals in the reset period, the address period, and the sustain period to the pairs of R, G, and B discharge electrodes.

The present invention also discloses a plasma display panel including a first substrate facing a second substrate, and a plurality of discharge cells between the first substrate and the second substrate. A first discharge electrode pair, a second discharge electrode pair, and a third discharge electrode pair generate a discharge in a discharge cell. A first fluorescent layer emits red light in response to a discharge between the first discharge electrode pair, a second fluorescent layer emits green light in response to a discharge between the second discharge electrode pair, and a third fluorescent layer emits blue light in response to a discharge between the third discharge electrode pair. The first fluorescent layer, the second fluorescent layer, and the third fluorescent layer are arranged in the discharge cell.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the Is principles of the invention.

FIG. 1 is an exploded perspective view of a conventional three-electrode surface-discharge plasma display panel.

FIG. 2 is cross-sectional view along line II-II of the plasma display panel of FIG. 1.

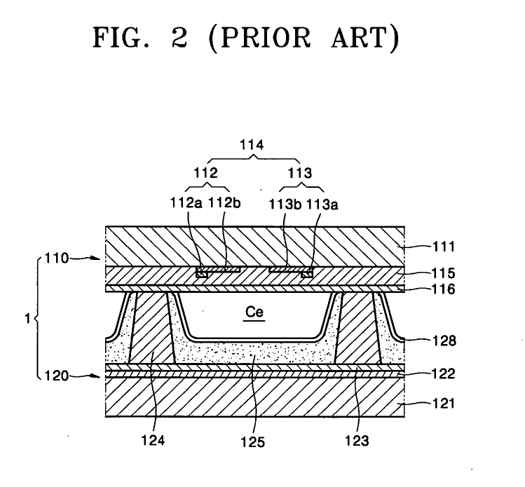

FIG. 3 is a diagram schematically illustrating an electrode arrangement of FIG. 1.

FIG. 4 is block diagram schematically illustrating a device for driving the plasma display panel of FIG. 1.

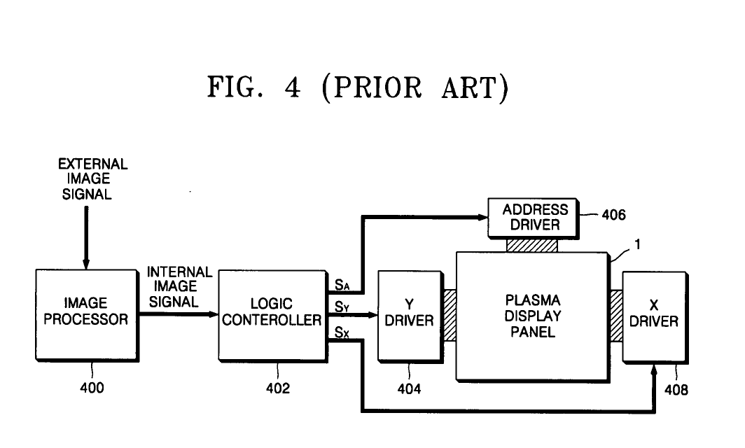

FIG. 5 is a diagram illustrating driving signals for driving the plasma display panel of FIG. 1.

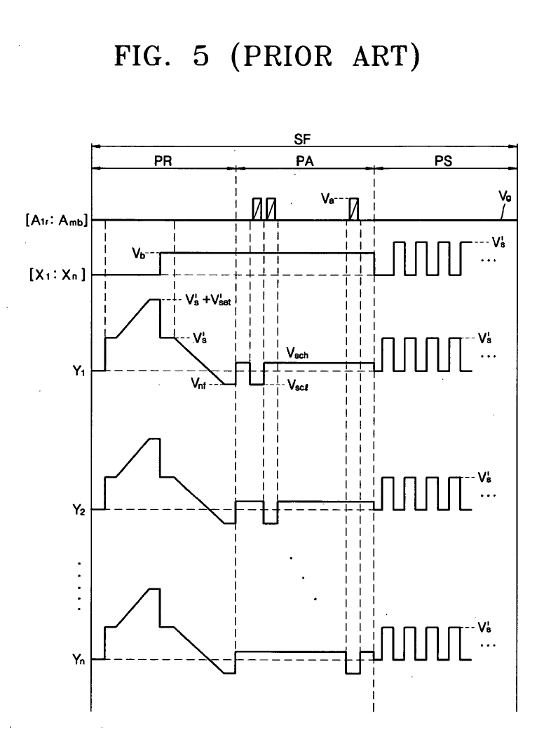

FIG. 6 is an exploded perspective view illustrating a plasma display panel according to an exemplary embodiment of the present invention.

FIG. 7 is a cross-sectional view along line III-III of FIG. 6.

FIG. 8 is a cross-sectional view along line IV-IV of FIG. 7.

FIG. 9 is a diagram illustrating discharge cells and pairs of discharge electrodes of FIG. 6.

FIG. 10 is a diagram schematically illustrating an electrode arrangement of the plasma display panel of FIG. 6.

FIG. 11 is a block diagram schematically illustrating a device for driving the plasma display panel of FIG. 6.

FIG. 12 is a diagram illustrating driving signals for driving the plasma display panel of FIG. 6 according to an exemplary embodiment of the present invention.

FIG. 13 is a diagram illustrating driving signals for driving the plasma display panel of FIG. 6 according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity.

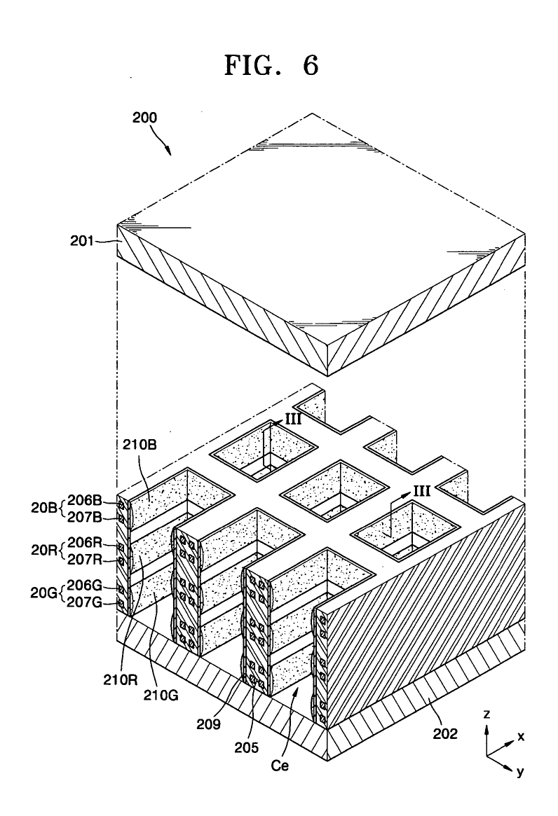

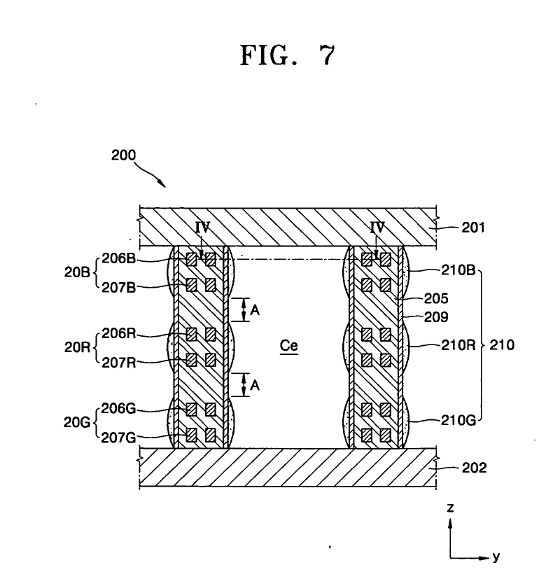

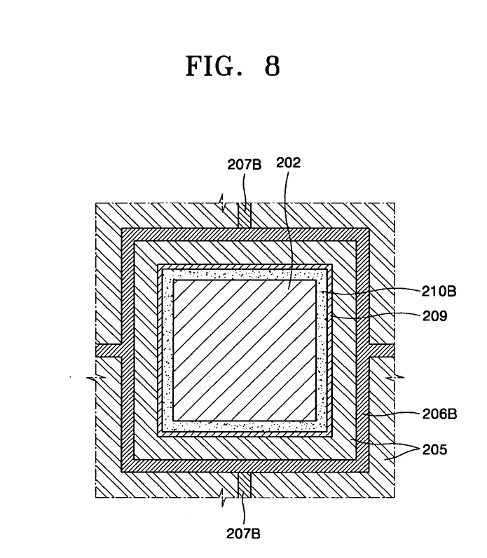

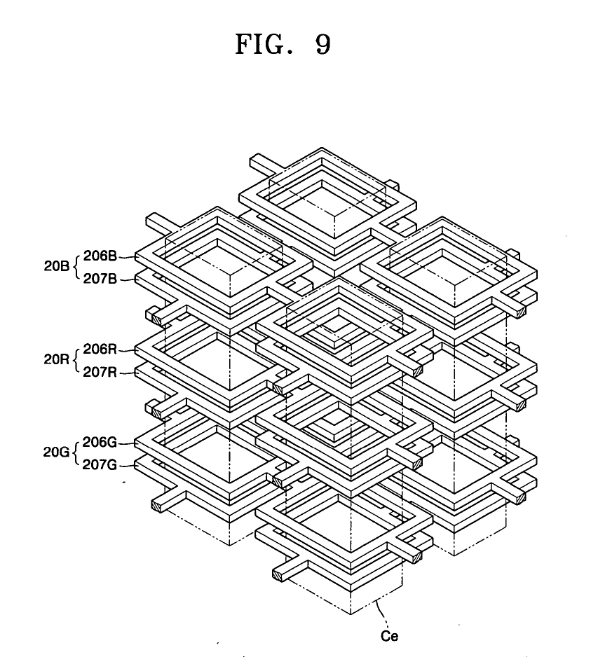

FIG. 6 is an exploded perspective view illustrating a plasma display panel according to an exemplary embodiment of the present invention. FIG. 7 is a cross-sectional view along line III-III of FIG. 6, FIG. 8 is a cross-sectional view along line IV-IV of FIG. 7, and FIG. 9 is a diagram illustrating discharge cells and pairs of discharge electrodes of FIG. 6.

A structure of a high resolution plasma display panel according to exemplary embodiments of the present invention will be described below with reference to FIG. 6, FIG. 7, FIG. 8 and FIG. 9.

Referring to FIG. 6, a plasma display panel 200 includes a first substrate 201, a second substrate 202, pairs of R, G, B discharge electrodes 20R, 20G, 20B, a fluorescent layer 210, partition walls 205, and discharge gas (not shown).

The first substrate 201 and the second substrate 202 face each other and are spaced apart by a predetermined distance. The transparent first substrate 201 is made of materials having good light transmittance such as glass. In the present embodiment, an image is displayed in the direction of the first substrate 201, but the direction that an image is displayed is not limited to the direction of the first substrate 201. Rather, an image may be displayed in the direction of the second substrate 202 or in both directions. In order to display an image in the direction of the second substrate 202, it is preferable that the second substrate be transparent.

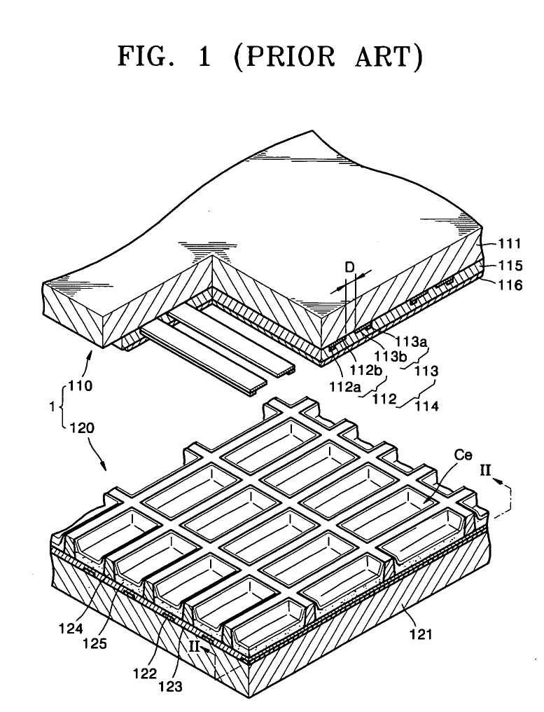

Transmittance of visible rays toward the front side may be significantly improved over the conventional panel of FIG. 1 because the first substrate 201 does not include pairs of sustain electrodes 114, the first dielectric layer 115, and the protective layer 116 shown in FIG. 1. With the conventional panel, transmittance of visible rays may be about 60%, while in the present invention, transmittance of visible rays may be 90% or more. Therefore, if an image is produced at the same brightness level as a conventional level, it is possible to drive the discharge electrodes at a relatively lower voltage, thereby improving light emitting efficiency.

Referring to FIG. 6, the partition walls 205 are arranged between the first substrate 201 and the second substrate 202, and they define a plurality of discharge cells Ce. When the discharge cells Ce have a transverse cross-section in a quadrilateral shape, they are generally arranged in a matrix shape. As long as the partition walls form a plurality of discharge cells, they may be arranged in various shapes such as waffle shape, delta shape, etc. Further, a transverse cross-section of the discharge cells may be a polygonal shape such as triangle, pentagon, etc. or the archetype or oval shape, etc. in addition to the quadrilateral shape shown in FIG. 6. The partition walls 205 prevent erroneous discharges between the discharge cells Ce from occurring.

As shown in FIG. 8 and FIG. 9, pairs of R, G, B discharge electrodes 20R, 20G, 20B are arranged to enclose the discharge cells Ce. The pairs of R, G, B discharge electrodes 20R, 20G, 20B are spaced apart from each other from the rear to the front of the panel (i.e.. the z direction of FIG. 6 and FIG. 7). The R, G, B discharge electrodes are made of a conductive metal such as silver, aluminum, copper, etc.

The pairs of B discharge electrodes 20B include B sustain electrodes 206B and B scan electrodes 207B, which extend substantially perpendicular to each other and are arranged inside the partition walls 205. Further, the B sustain electrodes 206B and the B scan electrodes 207B are arranged to enclose the discharge cells Ce.

The pairs of R discharge electrodes 20R are arranged behind (i.e. in a -Z direction) the pairs of B discharge electrodes 20B, and they include R sustain electrodes 206R and R scan electrodes 207R. The R sustain electrodes 206R and the R scan electrodes 207R extend substantially perpendicular to each other and are arranged inside the partition walls 205. Further, the R sustain electrodes 206R and the R scan electrodes 207R are arranged to enclose the discharge cells Ce.

The pairs of G discharge electrodes 20G are arranged behind (i.e. in the -Z direction) the pairs of R discharge electrodes 20R, and they include G sustain electrodes 206G and G scan electrodes 207G. The G sustain electrodes 206G and the G scan electrodes 207G 5 extend substantially perpendicular to each other and are arranged inside the partition walls 205. Further, the G sustain electrodes 206G and the G scan electrodes 207G are arranged to enclose the discharge cells Ce.

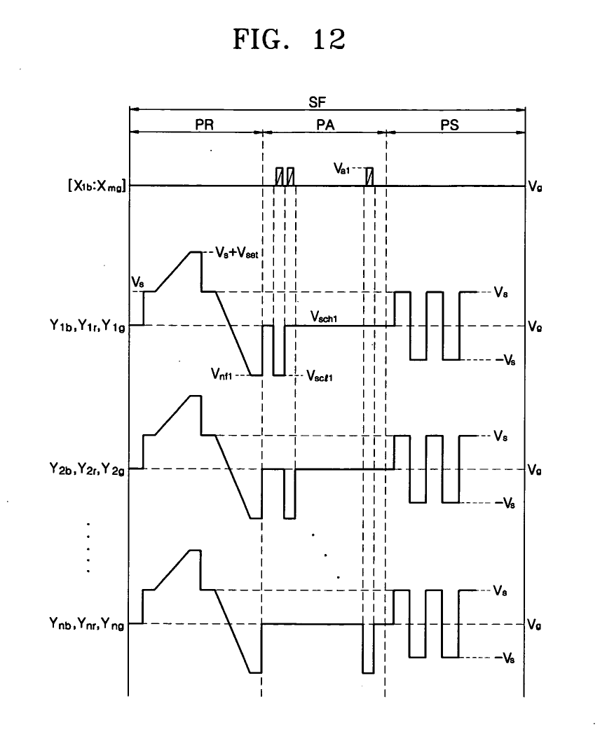

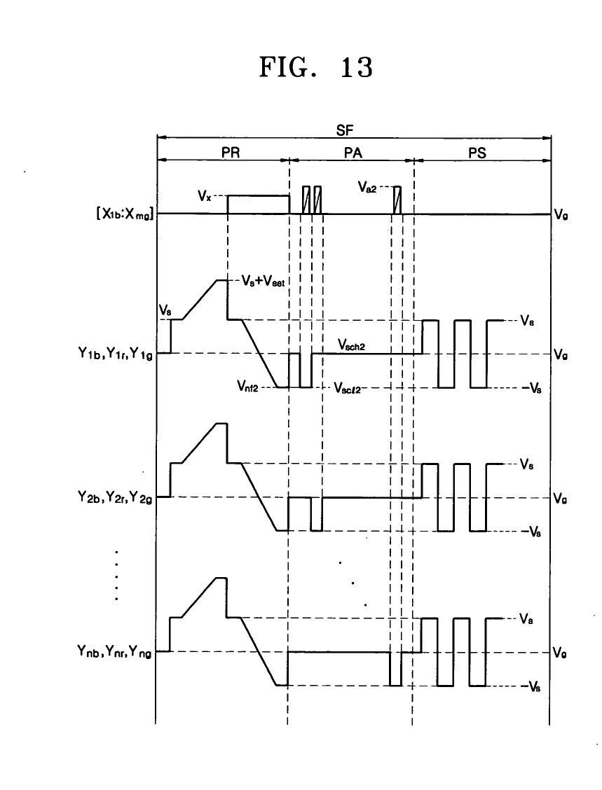

In the present exemplary embodiment, the R, G, B sustain electrodes 206R, 206G, 206B are involved in the address discharge because display data signals, which have an address voltage (Val of FIG. 12, Va2 of FIG. 13), are applied to the R, G, B sustain electrodes during an address period (PA of FIG. 12 and FIG. 13), and they are also involved in the sustain discharge because a ground voltage (Vg of FIG. 12 and FIG. 13) is applied to them during a sustain period (PS of FIG. 12 and FIG. 13). The R, G, B scan electrodes 207R, 207G, 207B are involved in the address discharge because a scan pulse is applied to the R, G, B scan electrodes during the address period (PA of FIG. 12 and FIG. 13), and they are also involved in the sustain discharge because the sustain pulse is applied to them during the sustain period (PS of FIG. 12 and FIG. 13).

The partition walls 205 prevent the pairs of R, G, B discharge electrodes 20R, 20G, 20B from being directly electrically connected, and they protect the electrodes from being damaged by direct collision with charged particles during discharge. The partition walls 205 may be made of a dielectric substance, such as PbO, B₂O₃, SiO₂, etc., so that the walls may store wall charges by deriving charged particles.

A protective layer 209, which may be an MgO layer, may cover the sides of the partition walls 205. The protective layer 209 prevents the partition walls 205 from being damaged and emits secondary electrons during discharging. The protective layer 209 may be formed as a thin film by sputtering or E-beam evaporation.

The fluorescent layer 210 is arranged inside the discharge cells Ce. Specifically, fluorescent layer 210R, which emits red light, fluorescent layer 210G, which emits green light, and fluorescent layer 210B, which emits blue light, are arranged inside each discharge cell Ce. The fluorescent layers 210R, 210G, and 210B may be arranged in various positions. In the exemplary embodiment of FIG. 6 and FIG. 7, the fluorescent layer 210B is arranged to be adjacent to partition walls 205 in which the pairs of B discharge electrodes 20B are arranged. Specifically, the fluorescent layer 210B is arranged on the protective layer 209 at a portion of the partition walls 205 where the pairs of B discharge electrodes 20B are buried. Similarly, the fluorescent layer 210R is arranged on the protective layer 209 at a portion of the partition walls 205 where the pairs of R discharge electrodes 20R are buried. Further, the fluorescent layer 210G is arranged on the protective layer 209 at a portion of the partition walls 205 where the pairs of G discharge electrodes 20G are buried. Therefore, the pairs of B discharge electrodes 20B are involved in light emitting of the fluorescent layer 210B, the pairs of R discharge electrodes 20R are involved in light emitting of the fluorescent layer 210R, and the pairs of G discharge electrodes 20G are involved in light emitting of the fluorescent layer 210G.

The fluorescent layer 210 includes a component that receives ultraviolet rays 20 generated by discharges between the pairs of R, G, B discharge electrodes 20R, 20G, 20B and emits visible rays. The fluorescent layer 210R may include a fluorescent substance such as Y (V, P) 0₄:Eu, the fluorescent layer 210G may include a fluorescent substance such as Zn₂SiO₄:Mn, YBO₃:Tb, and the fluorescent layer 210B may include a fluorescent substance such as BAM:Eu.

As shown in FIG. 7, the fluorescent layers 210B, 210R, and 210G are arranged inside one discharge cell Ce and are spaced apart from each other by a distance A in order to prevent erroneous discharge from occurring inside the discharge cells. Specifically, when ultraviolet rays occurring during the time of discharging by the pairs of B discharge electrodes 20B enter the fluorescent layer 210R or 210G, rather than the fluorescent layer 210B, undesirable red light or green light may be created. Therefore, ultraviolet rays generated by the pairs of B discharge electrodes 20B should be incident only on the fluorescent layer 210B, ultraviolet rays generated by the pairs of R discharge electrodes 20R should be incident only on the fluorescent layer 210R, and ultraviolet rays generated by the pairs of G discharge electrodes 20G should be incident only on the fluorescent layer 210G. Considering that the wavelength of ultraviolet rays used for creating visible rays is generally 147 nm or 173 nm, and that ultraviolet rays having these wavelength have difficultly transmitting a distance of about 200 μm or more, it is preferable that the distance A between the fluorescent layers is about 200 m or more.

A discharge gas such as Ne, Xe, etc. and a mixture thereof is filled and sealed inside the discharge cells Ce. According to exemplary embodiments of the present invention, an amount of generated plasma increases and the low-voltage driving may be possible since the discharge area may be increased and the discharge space may be enlarged. Therefore, even if Xe gas having a high partial pressure is included in the discharge gas, low-voltage driving may be possible, whereby luminous efficiency may be substantially improved. This solves the difficulty of low-voltage driving when the Xe gas has a high partial pressure.

In the plasma display panel 200 having the above-mentioned structure, address discharge occurs because display data signals and scan pulses are applied between the sustain electrodes 206B, 206G, 206R and the scan electrodes 207B, 207G, 207R. The address discharge selects pairs of discharge electrodes inside the discharge cells in which the sustain discharge is to occur, and the sustain discharge is performed in the selected pairs of discharge electrodes. Ultraviolet rays are emitted while the energy level of discharge gas excited by the sustain discharge decreases. These ultraviolet rays excite the fluorescent layer 210B, 210R, 210G coated inside the discharge cells Ce, and visible rays are emitted while the energy level of the excited fluorescent layer 210B, 210R, 210G decreases, thereby forming an image. For example, in order to create white light in one discharge cell Ce, the address discharge should be performed in the pairs of red, green, and blue discharge electrodes 20R, 20G, 20B, and then the sustain discharge should be performed by applying sustain pulses to the pairs of red, green, and blue discharge electrodes. Further, in order to create red light in one discharge cell Ce, after the address discharge is performed in only the pairs of R discharge electrodes 20R, the sustain discharge should be performed by applying sustain pulses.

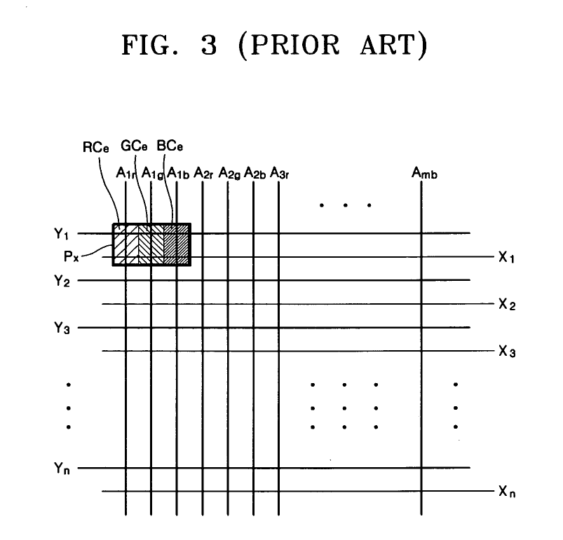

In exemplary embodiments of the present invention, each discharge cell Ce includes the R discharge cell, the G discharge cell, and the B discharge cell and forms a unit pixel for forming an image. To the contrary, in the conventional panel of FIG. 1, each discharge cell is either a R discharge cell, a G discharge cell, or a B discharge cells, and each discharge cell corresponds to a sub-pixel. Hence, in the present invention, one discharge cell can form a unit pixel that is ⅓ the size of a conventional pixel, and there may be three times more unit pixels in the panel, which may triple the panel's resolution. However, in order to do so, when there are n scan electrode lines and sustain electrode lines, and 3m R, G, B address electrode lines, included in the plasma display panel having the conventional three-electrode surface-discharge structure shown in FIG. 3, 3n scan electrode lines and 3m sustain electrode lines are included in the plasma display panel 200 having a two-electrode surface-discharge structure according to the present embodiment.

In the conventional plasma display panel of FIG. 1, a discharge area is relatively narrow because the sustain discharge between the sustain electrodes 113 and the scan electrodes 112 occurs in the horizontal direction of the first substrate 111. However, the sustain discharge of the plasma display panel 200 according to the present embodiment may occur in all side surfaces defining the discharge cells Ce, and the discharge area is relatively wide. Further, in the present embodiment, the sustain discharge gradually diffuses to central portions of the discharge cells Ce after occurring in a closed curve shape along side surfaces of the discharge cells Ce. Accordingly, an area in which the sustain discharge occurs increases, and space charges inside the discharge cells Ce, which have not been frequently used, contribute to light emitting, thereby enhancing the panel's light emitting efficiency.

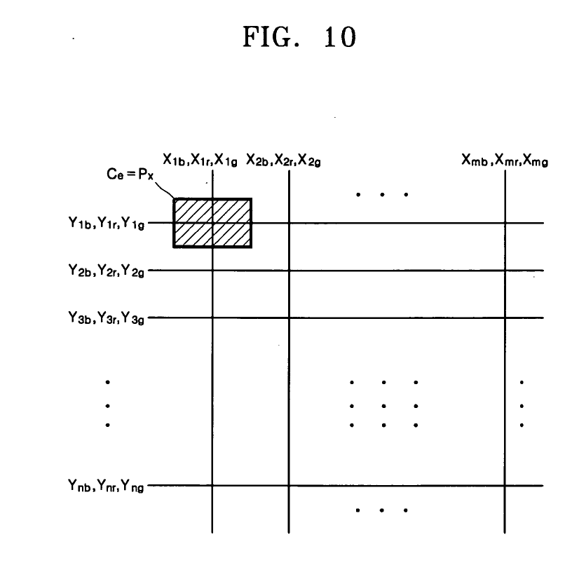

FIG. 10 is a diagram schematically illustrating a two dimensional electrode arrangement of the plasma display panel of FIG. 6.

Referring to FIG. 10, when the plasma display panel 200 includes m×n pixels, 3n scan electrode lines, which include n B scan electrodes lines Y1b, . . . , Ynb, n R scan electrode lines Y1r, . . . , Ynr, and n G scan electrode lines Y1g, . . . , Yng, are arranged in the row direction of the panel, and 3m sustain electrode lines, which include m B sustain electrode lines X1b, . . . ,Xmb, m R sustain electrode lines X1r, . . . ,Xmr, and m G sustain electrode lines X1g, . . . ,Xmg, are arranged in the column direction of the panel. Here, one discharge cell Ce may display red, green and blue, and a mixed color thereof, and a unit pixel Px includes one discharge cell Ce. On the other hand, as shown in the conventional electrode arrangement of FIG. 3, one discharge cell is a red, green, or blue sub-pixel, and the red, green, and blue sub-pixels (BCe, RCe, and GCe of FIG. 3) form a unit pixel Px. Therefore, the plasma display panel 200 may have three times as many unit pixels as the conventional panel of FIG. 1, thereby tripling the resolution.

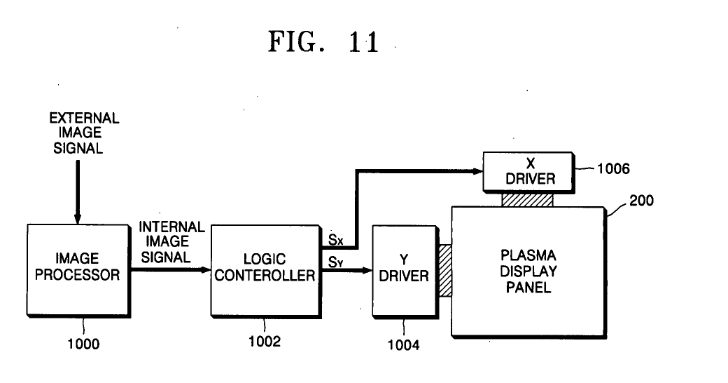

FIG. 11 is a block diagram schematically illustrating a device for driving the plasma display panel of FIG. 6.

Since a plasma display panel according to an embodiment of the present invention may include a novel two-electrode structure, the device for driving the plasma display panel may be made more compact, as compared to a conventional device.

Referring to FIG. 11, the device for driving the plasma display panel 200 includes an image processor 1000, a logic controller 1002, a Y driver 1004, and an X driver 1006.

The image processor 1000 receives an image signal such as a PC signal, a DVD signal, and a TV signal, and converts analog image signals into digital image signals. It then processes the digital signals into internal image signals. The internal image signals include 8-bit R, G, B image data, clock signals, and vertical and horizontal synchronization signals.

The logic controller 1002 receives the image signals and outputs X drive control signals S_{X} and Y drive control signals S_{Y} after performing gamma correction, automatic power control (APC), etc.

The Y driver 1004 receives the Y drive control signals S_{Y} and applies a reset pulse including a rising ramp and a falling ramp to initialize the discharge cells during a reset period (PR of FIG. 12 and FIG. 13), sequentially applies a scan pulse having a negative low scan voltage (Vscl1 of FIG. 12, Vscl2 of FIG. 13) in the vertical direction of the panel 200 while biasing the Y electrodes at a positive high scan voltage (Vsch1 of FIG. 12, Vsch2 of FIG. 13) during the address period (PA of FIG. 12 and FIG. 13), and applies a sustain pulse alternately having a positive sustain discharge voltage (Vs of FIG. 12 and FIG. 13) and a negative sustain discharge voltage (−Vs of FIG. 12 and FIG. 13) during a sustain discharge period (PS of FIG. 12 and FIG. 13), to the R,G,B scan electrode lines Y1b, . . . ,Yng of the plasma display panel 200, respectively.

The X driver 1006 receives the X drive control signal S_{X} and applies a ground voltage (Vg of FIG. 12) or a bias voltage (Vx of FIG. 13) during the reset period, a display data signal having an address voltage (Val of FIG. 12, Va2 of FIG. 13) to select cells to be turned on during the address period, and a ground voltage (Vg of FIG. 12 and FIG. 13) during the sustain period, to the R, G, B sustain electrode lines X1b, . . . Xmg, respectively.

FIG. 12 is a diagram illustrating an exemplary embodiment of driving signals for driving the plasma display panel of FIG. 6.

Referring to FIG. 12, a sub-field SF may be divided into the reset period PR, the address period PA, and the sustain period PS. The reset period PR initializes a state of wall charges around the pairs of R, G, B discharge electrodes of the discharge cells. In the reset period, a reset pulse including a rising ramp and a falling ramp is applied to the R,G, B scan electrode lines Y1b, . . . ,Yng. The rising ramp rises by a second voltage Vset from a first voltage Vs to reach the third voltage (Vset+Vs), which is the highest rising voltage. The falling ramp descends from the first voltage Vs to a fourth voltage Vnf1, which is the lowest falling voltage. The ground voltage Vg is applied to the R, G, B sustain electrode lines X1b, . . . , Xmg during the reset period PR. When applying the rising ramp, negative wall charges accumulate around the R, G, B scan electrodes, positive wall charges accumulate around the R, G, B sustain electrodes, and a weak discharge occurs between the R, G, B scan electrodes and the R, G, B sustain electrodes, respectively. When applying the falling ramp, some negative wall charges are removed around the R, G, B scan electrodes, some positive wall charges are removed around the R, G, B sustain electrodes, and a weak discharge occurs between the R, G, B scan electrodes and the R, G, B sustain electrodes, respectively. At the end of the reset period, a small amount of negative wall charges may remain at the R, G, B scan electrodes, and a small amount of positive wall charges may remain at the R, G, B sustain electrodes.

During the address period PA, a scan pulse and display data signals are applied to select discharge cells to be turned on, specifically, to select the pairs of R, G, B discharge electrodes to be turned on. The scan pulse has a sixth voltage Vscl1, which is a low scan voltage, after maintaining a fifth voltage Vsch1, which is a high scan voltage, and is sequentially applied to the R, G, B scan electrode lines Y1b, . . . ,Yng. The display data signals have a seventh voltage Va1, which is an address voltage, and are applied to the R, G, B sustain electrode lines X1b, . . . , Xmg to select discharge cells to be turned on depending on the scan pulse, specifically, to select the pair of R, G, B discharge electrodes.

The address discharge is generated between the R, G, B scan electrodes and the R, G, B sustain electrodes, respectively, by the negative wall charges accumulated around the R, G, B scan electrodes and the positive wall charges accumulated around the R, G, B sustain electrodes during the reset period, and by the negative sixth voltage Vscl1 applied to the R, G, B scan electrodes and the positive seventh voltage Val applied to the R, G, B sustain electrodes during the address period. The address discharge accumulates positive wall charges around the R, G, B scan electrodes and negative wall charges around the R, G, B sustain electrodes.

During the sustain period PS, the sustain pulse is applied to generate sustain discharge in the selected discharge cells, specifically, in the selected pairs of R, G, B discharge electrodes. The sustain pulse alternately has the positive first voltage Vs and the negative first voltage −Vs. The sustain pulse may further have a ground voltage Vg, which is a middle voltage ranging between the first voltages Vs and −Vs, to reduce power consumption due to the pulse's sudden voltage change. The sustain pulse is applied to the R, G, B scan electrode lines Y1b, . . . ,Yng, and the ground voltage Vg is applied to the R, G, B sustain electrode lines X1b, . . . ,Xmg.

When the positive first voltage Vs is applied, the sustain discharge is generated by the positive wall charges accumulated around the R, G, B scan electrodes, the negative wall charges accumulated around the R, G, B sustain electrodes, the positive first voltage Vs applied to the R, G, B scan electrodes, and the ground voltage Vg applied to the R, G, B sustain electrodes. The sustain discharge accumulates negative wall charges around the R, G, B scan electrodes and positive wall charges around the R, G, B sustain electrodes.

When the negative first voltage −Vs is applied, the sustain discharge is generated by the negative wall charges accumulated around the R, G, B scan electrodes, the positive wall charges accumulated around the R, G, B sustain electrodes, the negative first voltage −Vs applied to the R, G, B scan electrodes, and the ground voltage Vg applied to the R, G, B sustain electrodes. The sustain discharge accumulates positive wall charges around the R, G, B scan electrodes and negative wall charges around the R, G, B sustain electrodes.

Such sustain discharging may continuously occur by applying the sustain pulse depending on the gray-scale weight of the sub-field.

In the driving signals shown in FIG. 12, the fourth voltage Vnf1 and the sixth voltage Vscl1 are larger than the negative first voltage −Vs. In a two-electrode structure as in the present invention, in order to reach a discharge starting voltage by driving signals applied to each electrode, the fourth voltage Vnf1 and the sixth voltage Vscl1 should be higher than the negative first voltage −Vs. Here, the fourth voltage Vnf1 and the sixth voltage Vscl1 may be the same in order to reduce the number of supplied power levels. Because the reset pulse, the scan pulse, and the sustain pulse are applied to the R, G, B scan electrodes, and only display data signals are applied to the R, G, B sustain electrodes, the X driver of FIG. 10 may be simply embodied, as compared to a conventional X driver.

FIG. 13 is a diagram illustrating driving signals for driving the plasma display panel of FIG. 6 according to another exemplary embodiment of the present invention. The driving signals of FIG. 13 are similar to those of FIG. 12, but they have different power levels that may be applied to each electrode.

Driving signals of FIG. 13 will be described below without describing states of the wall charges inside the discharge cells, which were described with reference to FIG. 12.

First, during the reset period PS for initializing all discharge cells, a reset pulse including a rising ramp and a falling ramp is applied to the R, G, B scan electrode lines Y1b, . . . , Yng in order to initialize a state of wall charges around the pairs of R, G, B discharge electrodes. The rising ramp rises by the second voltage Vset from the first voltage Vs to reach the third voltage (Vset+Vs), and the falling ramp descends from the first voltage Vs to the fourth voltage Vnf2. The R, G, B sustain electrode lines X1b, . . . , Xmg are biased at the eighth voltage Vx while the falling ramp is applied to the R, G, B scan electrode lines.

During the address period PA, the scan pulse and display data signals are applied in order to select discharge cells to be turned on, specifically, to select the pairs of R G, B discharge electrodes inside the discharge cells that should be turned on. The scan pulse includes the fifth voltage Vsch2 as a high level and the sixth voltage Vscl2 as a low level. The low level scan pulse is sequentially applied to the R, G, B scan electrode lines Y1b, . . . , Yng, and the display data signals have a seventh voltage Va2 depending on the scan pulse and are applied to the R, G, B sustain electrode lines X1b, . . . , Xmg.

During the sustain period PS, the sustain pulse is applied to generate sustain discharge in the selected discharge cells, specifically, in the selected pairs of R, G, B discharge electrodes. The sustain pulse has the positive first voltage Vs and the negative first voltage -Vs. The sustain pulse may further have the ground voltage Vg, which is a middle voltage between the positive first voltage Vs and the negative first voltage −Vs, in order to reduce power consumption due to the sudden voltage change. The sustain pulse is applied to the R, G, B scan electrode lines Y1b, . . . , Yng, and the ground voltage Vg is applied to the R, G, B sustain electrode lines X1b, . . . ,Xmg.

A feature distinguishing the signals of FIG. 13 from the signals of FIG. 12 is that the eighth voltage Vx is applied to the R, G, B sustain electrode lines X1b, . . . ,Xmg in the reset period PR while applying the falling ramp. Additionally, because the fourth voltage Vnf2 and the sixth, voltage Vscl2 need not be higher than the negative first voltage −Vs in terms of the discharge starting voltage in FIG. 13, it is preferable that the fourth voltage Vnf2, the sixth voltage Vscl2, and the negative first voltage −Vs have the same magnitude in order to reduce the number of supplied power levels. The seventh voltage Va2 of the address period PA of FIG. 13 may be higher than the seventh voltage Va1 of the address period PA of FIG. 12 in order to compensate for the fourth voltage Vnf2, which is decreased as compared to Vnf1 of FIG. 12. As described above, because the driving signals shown in FIG. 13 simplify power levels compared to those of FIG. 12, a production cost of a power supply device (not shown) for supplying power in each driver may be reduced.

According to exemplary embodiments of the present invention, the following effects may be obtained.

A plasma display panel may have three times the resolution of a conventional panel because the pairs of R, G, B discharge electrodes are arranged inside one discharge cell, which forms a unit pixel.

Because the pairs of R, G, B discharge electrodes are formed inside partition walls to enclose the discharge cells, discharge space during discharge is greater than that of a three-electrode surface-discharge structure, and typically unused space charges inside the discharge cells contribute to light emitting, thereby increasing discharge efficiency.

Even if Xe gas at a high partial pressure is used in the discharge gas, low-voltage driving may be possible, thereby improving light emitting efficiency.

Because electrodes are arranged inside partition walls, a transparent substrate may be used as the first substrate and/or the second substrate, thereby enabling a panel that may emit light out of two sides.

Since a panel of the present invention has a two-electrode structure, a driving device for applying driving signals to electrodes may have a more compact structure, compared to that of a conventional panel, thereby reducing production cost.

Since discharges may be generated using common power supply levels when applying driving signals in a plasma display panel according to embodiments of the present invention, the cost of producing a power supply device may be reduced.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A plasma display panel, comprising:
a first substrate;
a second substrate facing the first substrate;
partition walls arranged between the first substrate and the second substrate and defining a plurality of discharge cells;
a first discharge electrode pair, a second discharge electrode pair, and a third discharge electrode pair for generating a discharge in a discharge cell;
a first fluorescent layer for emitting red light, a second fluorescent layer for emitting green light, and a third fluorescent layer for emitting blue light arranged in the discharge cell; and
a discharge gas in the discharge cell.

2. The plasma display panel of claim 1, wherein the first discharge electrode pair, the second discharge electrode pair, and the third discharge electrode pair are arranged in the partition walls.

3. The plasma display panel of claim 2, wherein the partition walls comprise a dielectric substance.

4. The plasma display panel of claim 1, wherein the first discharge electrode pair, the second discharge electrode pair, and the third discharge electrode pair enclose the discharge cell.

5. The plasma display panel of claim 1, wherein the first discharge electrode pair, the second discharge electrode pair, and the third discharge electrode pair are spaced apart from each other in a direction that the first substrate and the second substrate are spaced apart from each other.

6. The plasma display panel of claim 1, wherein the first discharge electrode pair, the second discharge electrode pair, and the third discharge electrode pair comprise first electrodes extending in a direction substantially parallel to the first substrate and the second substrate, and second electrodes extending in a direction substantially perpendicular to the direction the first electrodes extend.

7. The plasma display panel of claim 1, wherein the first fluorescent layer is arranged adjacent to the first discharge electrode pair, the second fluorescent layer is arranged adjacent to the second discharge electrode pair, and the third fluorescent layer is arranged adjacent to the third discharge electrode pair.

8. The plasma display panel of claim 7, wherein the first fluorescent layer is arranged between the second fluorescent layer and the third fluorescent layer, and a gap of at least 200 μm is between the first fluorescent layer and the second fluorescent layer and between the first fluorescent layer and the third fluorescent layer.

9. The plasma display panel of claim 1, further comprising a protective layer covering at least side surfaces of the partition walls.

10. The plasma display panel of claim 1, wherein at least one of the first substrate and the second substrate is transparent.

11. A method of driving a plasma display panel comprising:
a first substrate and a second substrate;
partition walls arranged between the first substrate and the second substrate and defining a plurality of discharge cells;
pairs of red (R), green (G), and blue (B) discharge electrodes arranged in the partition walls, each pair of R, G, and B discharge electrodes comprising a first electrode and a second electrode arranged substantially perpendicular to each other;
a fluorescent layer emitting red, green, and blue light arranged adjacent to the pairs of R, G, and B discharge electrodes; and
discharge gas in the discharge cells, the method comprising:
dividing a unit frame into a plurality of sub-fields having respective gray-scale weights, a sub-field being divided into a reset period for initializing the discharge cells, an address period for selecting discharge cells to be turned on, and a sustain period for performing sustain discharge in the selected discharge cells corresponding to the respective gray-scale weight; and
applying driving signals in the reset period, the address period, and the sustain period to the pairs of R, G, and B discharge electrodes.

12. The method of claim 11, wherein a reset pulse comprising a rising ramp and a falling ramp is applied in the reset period, a scan pulse and a display data signal are applied in the address period, and a sustain pulse is applied in the sustain period.

13. The method of claim 12, wherein:
the rising ramp rises by a second voltage from a first voltage to reach a third voltage, the falling ramp descends from the first voltage to reach a fourth voltage, and the rising ramp and the falling ramp are applied to the first electrodes;
the scan pulse has a sixth voltage after maintaining a fifth voltage and is applied to the first electrodes, and display data signals have a seventh voltage and are applied to the second electrodes; and
the sustain pulse alternates between the first voltage having positive polarity and the first voltage having negative polarity and is applied to the first electrodes.

14. The method of claim 13, wherein the sustain pulse further comprises a ground voltage between the first voltage having positive polarity and the first voltage having negative polarity.

15. The method of claim 14, wherein at least on of the fourth voltage and the sixth voltage is larger than the first voltage.

16. The method of claim 14, wherein at least one of the fourth voltage and the sixth voltage is substantially the same as the first voltage.

17. The method of claim 16, wherein an eighth voltage having positive polarity is applied to the second electrodes while the falling ramp is applied to the first electrodes.

18. A plasma display panel, comprising:
a first substrate facing a second substrate;
a plurality of discharge cells between the first substrate and the second substrate;
a first discharge electrode pair, a second discharge electrode pair, and a third discharge electrode pair for generating a discharge in a discharge cell;
a first fluorescent layer for emitting red light in response to a discharge between the first discharge electrode pair;
a second fluorescent layer for emitting green light in response to a discharge between the second discharge electrode pair; and
a third fluorescent layer for emitting blue light in response to a discharge between the third discharge electrode pair,
wherein the first fluorescent layer, the second fluorescent layer, and the third fluorescent layer are arranged in the discharge cell.

19. The plasma display panel of claim 18, further comprising:
partition walls,
wherein the partition walls define the discharge cells, and the first discharge electrode pair, the second discharge electrode pair, and the third discharge electrode pair are arranged in the partition walls.

20. The plasma display panel of claim 18, wherein the first discharge electrode pair, the second discharge electrode pair, and the third discharge electrode pair enclose the discharge cell and are spaced apart from each other in a direction that the first substrate and the second substrate are spaced apart from each other.
